(19) United States
(12) Patent Application Publication
(10) Pub. No.: US 2006/0244910 A1
(43) Pub. Date: Nov. 2, 2006

(54) Lens having protection film that prevents moving of axis and damage of surface from the lens cutting and method and coating solution thereof

(76) Inventor: Sang wood Nam, Daejeon (KR)

Correspondence Address: WILLIAM COLLARD;COLLARD & ROE, P.C., 1077 NORTHERN BOULEVARD, ROSLYN, NY, 11576, US

(21) Appl. No.: 10/567,497

(22) PCT Filed: Aug. 20, 2003
(86) PCT No.: PCT/KR03/01676

§ 371 Date: Feb. 7, 2006

(30) Foreign Application Priority Data
Aug. 8, 2003 (KR) 10-2003-0054991

(51) Int. Cl. G02C 7/02

(52) U.S. Cl. 351/166

(57) ABSTRACT

The present invention relates to an eyeglass, and more particularly to an eyeglass having a protective film exhibiting a greater coefficient of friction than the lens and easy peeling and removal, formed on the surface of the eyeglass lens, so as to prevent a shift of an optical axis and damage of lens surface occurring when processing the eyeglass lens, in particular a high-slip lens, and further to prevent surface damage and aging occurring during transportation or storage of lenses shipped from the a manufacturing factory and preparation thereof, and a protective film coating solution for the same.

### TECHNICAL FIELD

The present invention relates to an eyeglass lens, and more particularly to an eyeglass lens having a protective film, which has a greater coefficient of friction than the lens and exhibits easy peeling and removal, formed on the surface of the eyeglass lens, so as to prevent a shift of an optical axis and damage to the lens surface occurring when processing the eyeglass lens, in particular the high-slip lens, and further to prevent surface damage and aging occurring during transportation or storage of the lens shipped from a manufacturing factory and a method for preparing the same, and a protective film coating solution for the same.

### BACKGROUND ART

Eyeglass lenses, fabricated in a circular shape and having a uniform diameter, are supplied to retail stores (optical shops), processed to fit into various shapes of eyeglass frames, with respect to consumers' preferences, by opticians, and then provided to consumers. When processing the lens to fit into the eyeglass frame, the optician selects lenses having refractivity capable of being precisely corrected with respect to consumers' eyesight and then processes them to fit into the eyeglass frame.

Refractivity of the lens (Diopter) is different depending on conditions of user's eyesight. Upon conventionally classifying the lens, a divergent lens (a virtual focus lens) is used for the nearsighted, while a convergent lens (a real focus lens) is used for the far-sighted. In addition, for the astigmatic eye having a focal distance differing between horizontal and vertical axes, the lens for correcting the distorted vision is used in which horizontal and vertical axes have different refractivities, respectively.

What is frequently used to process lenses so as to fit into the eyeglass frame is a lens edging machine. Although lens edging machines may have slight differences in their lens processing methods, depending on manufacturers thereof, the basic principle involves processing the eyeglass lens by first preparing a basic prototype pattern for making a model of the eyeglass lens of which horizontal and vertical axes were confirmed, fixing the axis of the eyeglass lens to be processed, based on this pattern and rotating an abrasion resistant tool along the outline of the pattern to grind and process the eyeglass lens.

Depending on the lens edging machine products of different manufacturers, there are slight differences in the manner of fixing, to the lens chuck, the lens to be processed after identifying horizontal/vertical axes of the lens and confirming the optical axis of the lens. First, the method of fixing the lens to the lens chuck may be divided into an automatic pressure method and a manual pressure method. The automatic pressure method involves automatically applying appropriate pressure to cause the lens fixing chuck to grip both surfaces of the lens, while the manual pressure method involves artificially and manually applying appropriate pressure to cause the lens fixing chuck to grip both surfaces of the lens. The lens chuck is a mean in contact with over the surface of the lens so as to fix the lens on the processing axis of the lens edging machine. There are two methods of fixing the eyeglass lens using the lens chucks, i.e., one method utilizing a vacuum attachment type chuck made of rubber material, and another method of attaching adhesive tape on the lens chuck made of plastic material and then attaching it on the surface of the lens through adhesivity and pressure imparted by the tape.

However, there are conventional problems associated with edging the eyeglass lens, as described below.

First, impressions produced on the surface of the eyeglass lens by pressing the lens chuck after processing the lens, may interfere with a user's visual field.

Second, particularly in the case of a low reflective-coated lens, having a dielectric vapor deposited thereon, impact to the dielectric coated layer may cause cracks of the lens surface and film separation.

These events are more frequent in a urethane-based lens having a relatively weak surface strength (refractive index of 1.61 to 1.67) than in an aryl-based lens (refractive index of 1.56) and are common phenomena occurring in almost all lenses made of various materials even though there is more or less difference therebetween.

Thirdly, when processing the high-slip eyeglass lens, the center of the lens is shifted from the lens chuck in which the center of the lens is fixed and thus the horizontal/vertical axes of the lens may exhibit inconsistency with those of the prototype pattern after processing. In the case of the lens for correcting the distorted vision, when the horizontal/vertical axes of the prototype pattern are not consistent with those of the processed lens, negative effects, such as depreciation of vision correcting effects, and also lowering the visual power of the user wearing the eyeglass, may result.

In particular, where the outermost layer of the lens is formed of anti-fouling material containing fluorine (The prior Korean Patent No. 366262 in the name of the present applicant, entitled “Plastic eyeglass lens having a multiplicity of thin film reinforced-dielectric vapor deposited thereon and method for reinforcing the same”), or where a water repellent layer is formed as the outermost layer of the lens, slipperiness of the lens surface becomes very high, and thus the optical and horizontal/vertical axes of the lens are substantially shifted from the real center thereof. Accordingly, it is very difficult to process the lens and thus, if necessary, intentionally lowering the slipperiness of the eyeglass lens may be required. However, such lowering of the slipperiness of the eyeglass lens in turn results in deterioration of lens quality and thus is undesirable.

Further, plastic eyeglass lenses shipped from manufacturing factories are conventionally packaged and distributed with wrapping paper having protective ply-papers contained therein. During such a distribution process, the surface of the lens cannot be completely protected from surface damage such as flaws, adsorption of foreign materials and fingerprints, and thus it is difficult for the lens, delivered to the retail stores through this distribution process, to maintain the same surface conditions as the lens had before shipping. In particular, in the case of the plastic eyeglass lens having multiple thin films formed thereon for preventing reflection, deformation or chemical changes in the lens surface due to effects of temperature and humidity during such distribution process may be caused and, further, in the case of a UV absorber treated lens, discoloration of the lens (yellowing of the lens surface) due to UV absorption in the atmosphere may occur.

### DISCLOSURE OF THE INVENTION

Therefore, the present invention has been made in view of the above problems, and it is an object of the present invention to provide a protective film exhibiting greater coefficient of friction than the lens and easy peeling and removal after processing, formed on the surface of the lens, so as to effect precise correction of refractivity of the lens by inhibiting a shift of the axis while maintaining original slipperiness when processing an eyeglass lens, in particular a high-slip lens.

It is another object of the present invention to prevent surface damage to the lens such as cracks of the lens surface and film separation that may occur when processing the lens, by forming the above-mentioned protective film on the surface of the lens.

It is a further object of the present invention to protect the eyeglass lens from flaws or dust adsorption, damage due to contaminants and discoloration occurring on the lens surface during a distribution process of the lens, by forming the above-mentioned protective film on the surface of the lens.

### BEST MODE FOR CARRYING OUT THE INVENTION

In accordance with an aspect of the present invention, the above and other objects can be accomplished by the provision of an eyeglass lens having a protective film, which has greater coefficient of friction than the lens and exhibits easy peeling and removal after processing, formed on the surface of the eyeglass lens, using chlorinated polyolefin resin or PET (polyethyleneterephthalate), in order to prevent a shift of axes and surface damage when processing the lens.

Preferably, the chlorinated polyolefin resin is a chlorinated polypropylene resin.

Further, in accordance with the present invention, as the coating solution for forming the protective film, there is provided a liquid coating solution comprising, preferably, 10 to 20 parts by weight of a chlorinated polypropylene having a molecular weight of 20,000 to 200,000; 20 to 50 parts by weight of a ketone based organic solvent; and 10 to 70 parts by weight of an aromatic organic solvent.

In addition, in accordance with the present invention, there is provided a method for forming the protective film of the eyeglass lens by coating the coating solution on the surface of the eyeglass lens using any one of dipping, application, spray and spin coating methods.

The protective film formed on the surface of the eyeglass lens in accordance with the present invention is applied particularly to the eyeglass lens having a dielectric thin film layer, or the eyeglass lens having an anti-fouling thin film layer or water repellent layer containing fluorine, formed on the surface of the eyeglass lens, and thereby allows for the lens to be easily edging processed and prevents lens surface damage.

The phrase “processing the lens” as used herein means shaping and processing the lens to fit into the respective eyeglass frame at optical shops, as long as it is not particularly specified. Since such processing of the eyeglass lens is conventionally performed using a lens edging machine, and therefore, it is also called “edging or edge processing”, and the phrase “processing the lens” is used herein to encompass lens edging and edge processing.

The method for forming the protective film of the eyeglass lens in accordance with the present invention will now be described stepwise in more detail.

1. Preparation of Coating Material for a Protective Film

As the raw coating material, of the protective film, exhibiting a larger coefficient of friction than that of the lens, and allowing easily peeling and removal after processing the lens, a chlorinated polyolefin resin or PET (polyethyleneterephthalate) may be used in the present invention.

Although there is no particular limit to-the chlorinated polyolefin resin, a chlorinated polypropylene resin is preferably used. Alternatively, PET may be used in order to prepare a transparent and highly refractive liquid phase.

Solvent is added to provide a concentration and viscosity suitable for coating, to the chlorinated polyolefin resin so as to prepare a liquid coating solution. In this connection, although there is no particular limit to the solvent used, for example, a ketone based organic solvent such as methylethylketone(MEK) and an aromatic organic solvent such as toluene may be used.

The chlorinated polyolefin resin or PET is mixed with the solvent and stirred for a sufficient time to prepare a liquid coating solution. The mixing ratio of the raw materials may be controlled such that roughness of the coated surface is small and uniform when the coating solution is coated on the lens surface, transparency of the lens can be secured so as to confirm refractivity of the horizontal/vertical axes of the lens when edging, and printability can be secured so as to effect marking such as a discernment point. The preferred embodiment of the coating solution in accordance with the present invention comprises 10 to 20 parts by weight of a chlorinated polypropylene resin having a molecular weight of 20,000 to 200,000; 20 to 50 parts by weight of a ketone type organic solvent; and 10 to 70 parts by weight of an aromatic organic solvent.

2. Protective Film Coating

The coating solution thus prepared is coated to form a protective film on the lens surface. Dip coating by dipping the lens in the coating solution and drying, application coating, spray coating or spin coating may be used.

Dip coating is performed in order of the steps of placing the prepared coating solution in a bath, fixing the eyeglass lens on a fixing board capable of controlling speed of up and down movements thereof, lowering the lens at a predetermined speed to be dipped in the coating solution and raising the lens at a predetermined speed, and then removing and drying it. The lens surface that is coated while drying, forms a protective film layer in the form of a film. In this connection, precise control of the speed of the up and down movements of the lens may provide control of roughness and thickness of the film surface, and uniform coating. When dipping, lowering speed of the lens is preferably 5 to 30 mm/sec. Preferred raising speed of the lens is 0.5 to 5 mm/sec.

Alternatively, the dip coating may be performed in a manual dipping manner by fixing the lens on the fixing board, followed by artificially dipping and raising it.

Application coating is performed by directly applying an appropriate amount of the coating solution to both front and back surfaces of the lens with a paper or absorbable cloth soaked in the coating solution. Spray coating is performed by charging the coating solution in a container equipped with a spray nozzle and spraying it on both surfaces of the lens. In addition, spin coating is performed by fixing the lens on a high speed rotating tool, and then dropping the coating solution on the lens and rotating the lens at a high speed to coat the lens.

In order to form a thin and uniform protective film on the eyeglass lens, among the above-mentioned methods, it is preferred to use the dip coating capable of controlling up/down movement speed of the lens fixing board.

Coating may be made on both front and back surfaces of the lens, or if desired, on either the front surface or back surface of the lens only. Upon considering protective effects of the lens, it is preferred to coat both surfaces of the lens.

The eyeglass lens having the protective film formed thereon as described above, is packaged in a conventional method and distributed to the optical shops, and then processed to fit into the eyeglass frame selected by consumers.

The eyeglass lens having the protective film formed thereon in accordance with the present invention when processing can provide precise correction of refractivity since the protective film having a greater coefficient of friction inhibits rotational shift of the horizontal/vertical axes of the lens when processing.

The protective film in accordance with the present invention can be easily peeled from the lens after completing processing of the lens, as described above. Generally, if the lens is processed using a rotation processing tool, the protective film is naturally released from the lens surface when removing the fixing chuck from the processing-finished lens.

Now, the present invention will be described in more detail with reference to the following Examples. These examples are provided only for illustrating the present invention and should not be construed as limiting the scope and sprit of the present invention.

### EXAMPLES

### Example 1

Formation of Protective Film

(1) 10 g of chlorinated polypropylene resin (Hardlen 16-LP™, Toyo Kasei Kogyo Co., Ltd.), 40 g of methylethylketone and 20 g of toluene were mixed and stirred at about 50° C. for 5 hours using a stirrer equipped with an impeller and heater to obtain a liquid coating solution.

(2) The coating solution prepared in step 1 was placed in a bath, established in a space capable of being easily ventilated, and discharging indoor contaminating materials through an exhauster provided in the space, and the eyeglass lens was fixed on a lens fixing board capable of controlling speed of the up and down movement. Next, the eyeglass lens was dipped in the coating solution at a predetermined speed of 15 mm/sec and raised again at a predetermined speed of 1.5 mm/sec. And then the coated lens was dried in the drying zone equipped with a heated air dryer at 40° C. for 15 min to form the protective film of the present invention on the surface of the lens.

As the eyeglass lens in this example, the lens having myopic/astigmic axes of −3.50/−0.50 prepared according to the process of the prior Korean Patent No. 366262 in the name of the applicant of the present invention was used.

### Example 2

Lens Processing

The lens having the protective film prepared in Example 1 was edging processed and processability between this Example and Comparative Example was compared. As the Comparative Example, the same lens having myopic/astigmic axes of −3.50/−0.50 prepared according to the process of the prior Korean Patent No. 366262, as in Example 1, but without formation of the protective film, was used.

The lens was fixed on the lens edging machine (DS-500 DL, manual pressure type, GRAND) equipped with a rubber chuck and processed. After confirming the astigmic axes (horizontal/vertical axes) of the lens using a lensmeter (NIDEK) and marking discernment points (three points along the horizontal axis in order to indicate axial direction), lens processing was initiated. The same processing test was carried out three times. The results are shown in Table 1.

TABLE 1

| | Rotational shift of | Surface conditions of |
|---|---|---|
| | Axis | Lens |
| Example 1 | None | Chuck impressions not |
| | | found |
| Comparative | Shift of 20 to 25° | Chuck impressions found |
| Example | | |

### Example 3

Processing of Lens According to each Type of Different Lens Edging Machines

The lens having the protective film prepared in Example I was processed and tested using different types of lens edging machines listed in Table 2.

TABLE 2

| Types of lens edging | Shift of axis | Impressions by chuck |
|---|---|---|
| machines | (rotation) | after processing |
| TOPCON DP25 | Shift of less than 5° | Not found |
| Topcon ALE 100 DX | None | Not found |
| Takubo 600 V-2 | None | Not found |
| ESSILOR Kappa | None | Not found |
| Hoya HTC-100 | None | Not found |
| Nidek 3D-FIT LE-9000 SX | None | Not found |
| Nidek 3D-FIT LE-7070 | None | Not found |

### Example 4

Comparing Surface Damage after Packaging

20 of the lenses having the protective film prepared in the same manner as in Example 1 were provided. As the Comparative Example, 20 lenses having myopic/astigmic axes of −3.50/−0.50 prepared according to the process of the prior Korean Patent No. 366262, but without formation of the protective film, were used. The respective lenses thus prepared were packaged with conventional protective ply-packaging paper and then placed in a box. The box was shaken 100 times and the lenses were observed for surface conditions of the lenses. The protective films were removed from the protective film-coated lenses after shaking and surface conditions of the lenses were compared with the Comparative Example. The results are shown in Table 3.

TABLE 3

| | Example 1 | Comparative Example |
|---|---|---|
| Dust adsorption | Dust adsorption not | Adsorption of dust |
| | found when removing | from the protective ply- |
| | the protective film | paper found over the |
| | | entire surfaces of the |
| | | lenses |
| Surface damage | Surface damage | Flaws found in |
| | not found when | surfaces of 3 lenses |
| | removing the protective | |
| | film | |

### INDUSTRIAL APPLICABILITY

As confirmed from the above-mentioned Examples, the present invention realizes an eyeglass lens having a protective film on the surface of the lens, exhibiting a greater coefficient of friction than the lens and easy removal, thus almost completely eliminating optical axis shifting when processing the lens and being capable of precisely correcting refractivity, and preventing surface damage due to processing. Further, in accordance with the present invention, it is possible to prevent surface damage, adsorption of foreign materials, and contamination from the external environment occurring during distribution and handling of the eyeglass lens, and to protect the lens from effects of temperature and humidity, thereby being capable of inhibiting deformation and chemical changes in the lens surface. In particular, in accordance with the present invention, it is possible to overcome problems associated with shift of axis and surface damage occurring when processing the lens, regardless of the kinds of lens edging machines, and to minimize yellowing or aging that may occur due to prolonged distribution process of the eyeglass lens, by forming the above-mentioned protective film.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-8. (canceled)

9. A method for forming a protective film of an eyeglass lens, comprising coating a liquid coating solution containing 10 to 20 parts by weight of a chlorinated polyolefin resin having a molecular weight of 20,000 to 200,000; 20 to 50 parts by weight of a ketone based organic solvent; and 10 to 70 parts by weight of an aromatic organic solvent on the surface of the eyeglass lens,
wherein the eyeglass lens has a layer selected from the group consisting of a dielectric thin film layer; an anti-fouling thin film layer containing fluorine; and a water repellent layer, and
wherein the protective film has a greater coefficient of friction than the lens and exhibits easy peeling and removal after processing.

10. The method of claim 9, wherein the chlorinated polyolefin resin is a chlorinated polypropylene resin.

11. The method of claim 9, wherein the coating is performed by a method selected from the group consisting of dipping; application; spray and spin coating method.

12. The method of claim 9, wherein the coating is performed by a dip coating method comprising, in order of the steps of fixing the eyeglass lens on a fixing board; lowering the lens at a predetermined speed to be dipped in the coating solution and raising again the lens at a predetermined speed; and then removing and drying it.
